(19) United States
(12) Patent Application Publication
(10) Pub. No.: US 2022/0222394 A1
(43) Pub. Date: Jul. 14, 2022

(54) ROOT CAUSE ANALYSIS IN THE SYNCHRONIZATION OF PARTIAL SIMULATIONS WITH AND WITHOUT REAL-TIME CAPABILITY

(71) Applicant: dSPACE GmbH, Paderborn (DE)

(72) Inventor: Gernot Deutenberg, Waldaschaff (DE)

(21) Appl. No.: 17/553,838

(22) Filed: Dec. 17, 2021

(30) Foreign Application Priority Data
Jan. 14, 2021 (DE) 102021100598.1

(51) Int. Cl. G06F 30/20

(52) U.S. Cl. CPC G06F 30/20; G06F 2119/12

(57) ABSTRACT

A method for providing a simulation of a technical system includes: generating, by a partial simulation without real-time capability, a ping message; sending, by the partial simulation without real-time capability, the ping message to a partial simulation with real-time capability; and storing, by the partial simulation without real-time capability, in a log file, a pong message received from the partial simulation with real-time capability, or, in the event of no pong message being received from the partial simulation with real-time capability, storing, by the partial simulation without real-time capability, in the log file, the ping message.

### CROSS-REFERENCE TO PRIOR APPLICATIONS

This application claims benefit to German Patent Application No. DE 102021100598.1, filed on Jan. 14, 2021, which is hereby incorporated by reference herein.

### FIELD

The present invention relates to the simulation-based development of control units, such as are used, for example, in the automotive industry for controlling technical systems. In particular, the present invention relates to a device and a method for the root cause analysis of errors in the synchronization of partial simulations with real-time capability and those without real-time capability.

### BACKGROUND

The definition of real time in the standard DIN 44300 (Information processing), Part 9 (Processing procedures), which has now been replaced by DIN ISO/IEC 2382, reads: “Real time is understood to mean the operation of a computing system in which programs for processing incoming data are continuously operational in such a way that the processing results are available within a predetermined time period. Depending on the application, the data can be produced according to a random distribution or at predetermined points in time.”

In so doing, a so-called hard real time is assumed below. With a hard real time, the defined reaction time may never be exceeded. In contrast to this is the soft real time, which typically processes all arriving inputs quickly enough, but does not guarantee it, as is the case, for example, with many personal computers. Below, a system which only fulfills the soft real-time time is considered to be a non-real-time system; a simulation which calculates faster than real-time in most calculation steps but does not calculate within the defined time period in some calculation steps is considered to be a non-real-time simulation.

In modern development processes of control units, simulation methods are used very efficiently in order to develop and secure control unit software with a simulated image of the components to be controlled. Early predictions and correspondingly early concept decisions are significant success factors in such development processes. Starting from a distributed system development, distributed simulations or co-simulations are used, which make it possible to simulate subsystems in different simulation environments and with different simulation tools and to connect these partial simulations to one another. With the aid of co-simulation, different simulation models can thus be coupled and an overall system analysis can thereby be supported in very early stages of development.

Various standard models, such as the functional mock-up interface (FMI) standard, enable the coupling of any simulation models, in particular simulation models with and without real-time capability in a simulation environment. Models without real-time capability available from earlier development phases can thus be integrated into a simulation with real-time capability.

However, synchronization errors can occur in the coupling of simulation models with and without real-time capability due to lack of real-time conditions on the side of the coupling without real-time capability. For example, data from one or more simulation steps of a partial simulation can thus arrive with a delay or not at all on the part of the other partial simulation and thereby make further simulation calculations more difficult or lead to erroneous simulation results. This may result in an invalid system state of the overall system.

In order to find a cause of such synchronization errors and to remedy them if necessary, various manual analyses are usually used. For example, the execution speed of the simulation models can be analyzed. A reduction or adaptation of the model variable can subsequently be used in an attempt to increase the execution speed. On the part of the partial simulation without real-time capability, programs or services running in parallel to the simulator can be analyzed and, under certain circumstances, be reduced or interrupted in order to thereby also increase the execution speed of the simulation.

However, a disadvantage of the known methods is that they are based on manual analyses of the overall simulation and cannot be mapped to the different granularity and duration of individual simulation steps. A precise root cause analysis is thus not possible. Furthermore, these methods are based on the trial-and-error principle, as a result of which a targeted and effective resolution of the cause of the error is not possible.

### SUMMARY

In an exemplary embodiment, the present invention provides a method for providing a simulation of a technical system. The simulation comprises a partial simulation with real-time capability and a partial simulation without real-time capability coupled to the partial simulation with real-time capability. The partial simulation with real-time capability comprises a real-time system simulation time and a real-time system time and is configured to simulate a portion of the technical system in a plurality of real-time system simulation steps. The partial simulation without real-time capability comprises a non-real-time system simulation time and a non-real-time system time and is configured to simulate a further portion of the technical system in a plurality of non-real-time system simulation steps. The method includes: generating, by the partial simulation without real-time capability, a ping message; sending, by the partial simulation without real-time capability, the ping message to the partial simulation with real-time capability; and storing, by the partial simulation without real-time capability, in a log file, a pong message received from the partial simulation with real-time capability, or, in the event of no pong message being received from the partial simulation with real-time capability, storing, by the partial simulation without real-time capability, in the log file, the ping message.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 depicts a schematic view of a preferred simulation device according to the invention with a connected technical system to be tested;

FIG. 2 depicts a flow chart for exchanging ping and pong messages between the non-real-time simulation and the real-time simulation according to a preferred embodiment of the invention;

FIG. 3 depicts a preferred embodiment of a method according to the invention on the part of the partial simulation without real-time capability;

FIG. 4 depicts a further preferred embodiment of a method according to the invention;

FIG. 5 depicts further steps of a preferred embodiment of a method according to the invention;

FIG. 6 depicts an example of a log file according to a preferred embodiment according to the invention.

### DETAILED DESCRIPTION

Exemplary embodiments of the present invention provide a simulation device and a simulation method which overcome the aforementioned disadvantages discussed above in the background.

According to an exemplary aspect, a method for simulating a technical system is provided. The simulation is realized as a co-simulation comprising a partial simulation with real-time capability and a partial simulation without real-time capability coupled to partial simulation with real-time capability. The partial simulation with real-time capability comprises a real-time-system simulation time and a real-time system time and is configured to simulate a portion of the technical system in a plurality of real-time system simulation steps. The partial simulation without real-time capability comprises a non-real-time system simulation time and a non-real-time system time and is configured to simulate a further portion of the technical system in a plurality of non-real-time system simulation steps. On the part of the partial simulation without real-time capability, a ping message is generated in a first step. In a further step, the ping message is sent to the partial simulation with real-time capability. If a pong message sent by the partial simulation with real-time capability is received on the part of the simulation without real-time capability in a further step, the pong message is stored in a log file on the part of the partial simulation without real-time capability. If no pong message is received from the partial simulation with real-time capability, the ping message is stored in the log file.

According to a preferred embodiment, each sent ping message can be stored in the log file, irrespective of whether the partial simulation without real-time capability receives a corresponding pong message.

The partial simulation with real-time capability can, for example, simulate an environment of a technical system, such as a control unit, while the partial simulation without real-time capability executes components of the system to be controlled. This makes it possible to test implementations of a technical system which do not yet have real-time capability at a very early point in time of system development in a suitable environment.

At least one bi-directional communication link exists between the partial simulation with real-time capability and the partial simulation without real-time capability. Both partial simulations exchange the ping-pong messages via this link, and also simulation data for performing the simulation. The exchange of simulation data takes place at predetermined points in time, i.e., the partial simulation with real-time capability and the partial simulation without real-time capability work toward completing simulation data no later than the predetermined communication times and providing it to the respective other partial simulation.

However, if simulation data are not provided in time for the communication times, for example due to differently running clocks on the part of the two partial simulations or due to longer lasting calculations (“task overrun”), the respective partial simulations cannot perform their calculations or cannot perform them correctly. This leads to simulation errors such as, for example, an invalid overall system state in which the simulation is stopped or incorrect simulation results are obtained.

By exchanging ping and pong messages and storing these messages in the log file, it is possible, after termination of the simulation, to determine what has happened with the coupled system. In particular, from the order of the entries in the log file and from the ping-pong assignment of the messages after termination of the simulation, it can be determined with a high degree of accuracy in which of the partial simulations, in particular at which point in time and/or in which simulation step an error has occurred.

A method according to the invention thus provides a simulation environment which enables a precise root cause analysis of simulation errors which can occur in a synchronization of real-time and non-real-time partial simulations.

In the following, the terms “partial simulation with real-time capability”, “real-time simulation”, “real-time system”, “real-time side” are used synonymously and thus as interchangeable. The same applies to the terms “partial simulation without real-time capability”, “non-real-time simulation”, “non-real-time system”, “non-real-time side”.

According to a further embodiment, the ping message comprises a first non-real-time system timestamp based on the non-real-time system simulation time and a second non-real-time system timestamp based on the non-real-time system time.

From the additional timestamps of the ping message, which are contained in the received pong messages, it can be checked together with system logs or log files whether at a specific system time, i.e., in a specific simulation step, events occurred during the simulation which had a negative influence on the behavior of one of both partial simulations. It is thus possible to recognize with fine granularity and precisely causes of real-time breaches in the system simulation and to implement effective strategies for resolving them in a targeted manner.

According to a further embodiment, the simulation method on the part of the partial simulation without real-time capability further comprises the step of determining the current non-real-time system time and the current non-real-time system simulation time when receiving the pong message, wherein the pong message is stored together with the determined current non-real-time system time as a third non-real-time system timestamp and with the current non-real-time system simulation time as a fourth non-real-time system timestamp in the log file.

According to a further embodiment, the ping message is generated on the part of the partial simulation without real-time in each non-real-time system simulation step and sent to the partial simulation with real-time capability.

According to a further embodiment, the ping message is generated on the part of the partial simulation without real-time capability in each further non-real-time system simulation step and sent to the partial simulation with real-time capability after a pong message sent on the part of the partial simulation with real-time capability is received during the non-real-time system simulation step.

According to a further embodiment, on the part of the partial simulation with real-time capability, the method further comprises the steps of checking in each real-time system simulation step whether a calculation to be performed within a real-time system simulation step is terminated, and, if the calculation is terminated in the real-time system simulation step, generating a pong message and sending the pong message to the partial simulation without real-time capability.

According to a further embodiment, the pong message comprises a first real-time system timestamp based on the real-time system simulation time and a second real-time system timestamp based on the real-time system time.

According to a further embodiment, the pong message generated on the part of the partial simulation with real-time capability contains the ping message if a ping message has been received by the partial simulation without real-time capability in the real-time system simulation step in which the pong message is generated.

According to a further embodiment, the pong message generated on the part of the partial simulation with real-time capability does not contain any information about the ping message if no ping message has been received from the partial simulation without real-time capability on the part of the partial simulation with real-time capability in the real-time system simulation step in which the pong message is generated.

According to a further embodiment, a ping message is received on the part of the partial simulation with real-time capability only within a predetermined time window.

According to a further embodiment, the method further comprises the steps of evaluating the log file and activating a profiler based on the entries in the log file.

According to a further embodiment, the profiler is activated on the part of the partial simulation without real-time capability after termination of the simulation.

According to a further exemplary aspect, a simulation device for simulating a technical system is provided. The simulation device comprises a partial simulation with real-time capability and a partial simulation without real-time capability coupled to the partial simulation with real-time capability. The partial simulation with real-time capability comprises a real-time-system simulation time and a real-time-system system time and is configured to simulate a portion of the technical system in a plurality of real-time system steps. The partial simulation without real-time capability comprises a non-real-time system simulation time and a non-real-time system time and is configured to simulate a further portion of the technical system in a plurality of non-real-time system simulation steps. The partial simulation without real-time capability is further configured to generate a ping message to send the ping message to the partial simulation with real-time capability, to receive a pong message from the partial simulation with real-time capability, and to store the pong message in a log file.

According to a further embodiment, the ping message may comprise a first non-real-time system timestamp based on the non-real-time system simulation time and a second non-real-time system timestamp based on the non-real-time system time.

According to a further embodiment, the ping message may comprise a first real-time system timestamp based on the real-time system simulation time and a second real-time system timestamp based on the real-time system time.

According to a further embodiment, the partial simulation without real-time capability may be further configured to determine the current non-real-time system time and the current non-real-time system simulation time upon receiving the pong message, and to file them in the log file as a third non-real-time system timestamp and a fourth non-real-time system timestamp together with the pong message.

By enhancing the ping-pong messages on both sides of the co-simulation with timestamps, an accurate analysis of the simulation steps (non-real-time simulation steps and real-time simulation steps) after the completion/termination of the simulation is simplified, whereby accurate tracking of the cause of synchronization errors occurring during the simulation is supported.

According to a further embodiment, the simulation device may be further configured to determine the non-real-time system simulation steps based on the non-real-time system simulation time and the non-real-time system time and/or to determine the real-time system simulation steps based on the real-time system simulation time and the real-time system time.

As a result it is possible from the entries of the log file to determine the simulation step (i.e., the real-time system simulation step and/or the non-real-time system simulation step) in which a specific ping or pong message has been sent or received. By evaluating the log file, that simulation step (and thus also macro step of the simulator) in which an error has occurred during the simulation can thus be precisely determined. In conjunction with a profiler, system events or other processes which provoked the undesired behavior can also be identified.

According to a further embodiment, the simulation device is further configured to evaluate the log file and to activate a profiler based on the entries in the log file.

According to a further exemplary aspect, the invention relates to a computer program product comprising program codes which are stored on a computer-readable medium in order to execute a method according to the invention when the program is running on a computer.

According to the invention, an automatic method is thus provided which enables precisely identifying the simulation steps, both on the part of the partial simulation with real-time capability (real-time system simulation steps) and on the part of partial simulation without real-time capability (non-real-time system simulation steps) that potentially led to a real-time breach during simulation. This is particularly advantageous if the coupled partial simulations do not share a common time base or use different increments for the simulation.

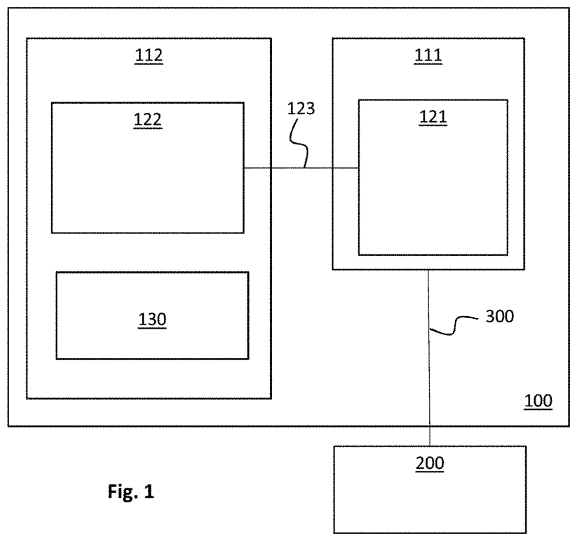

FIG. 1 schematically shows the structure of a device 100 according to the invention for simulating a technical system. The simulation device 100 includes a non-real-time simulator 112 and a real-time simulator 111. For example, the non-real-time simulator 112 is a simulation software on a computer, for example a personal computer (PC), which can run control unit code, in particular a virtual control unit. The non-real-time simulator cannot calculate in hard real time, i.e., it cannot supply data in every simulation step within a defined time span. A virtual control unit is, for example, rudimentary control unit code or even control unit code without the existing control unit hardware.

The real-time simulator 111 is, for example, a hardware-in-the-loop simulator (HIL). A real-time simulator guarantees the hard real time, i.e., that the defined reaction time is never exceeded. A partial simulation with real-time capability 121, such as an environmental model, is run on the real-time simulator. The partial simulation with real-time capability 121 is also configured to comply with hard real time, i.e., to always provide results within the defined reaction time.

The technical system 200 to be tested, for example an engine control unit for controlling the engine of a vehicle, is connected via a physical interface 300 to the simulation device 100, in particular to the real-time simulator 111. The simulation device 100, in particular the real-time simulator 111, may simulate the environment of the technical system 200 in real time and exchange data with the technical system 200 via the physical interface 300.

The real-time simulator 111 enables the technical system 200 to be tested in a realistic environment, i.e., in an environment that comes as close as possible to the environment in which the technical system is later put into operation.

The simulation device 100 comprises a plurality of partial simulations or sub-models which model different components of the system to be tested and its environment and which are coupled to one another in order to provide a real-time co-simulation of the overall system. FIG. 1 shows a partial simulation with real-time capability 121 and a partial simulation without real-time capability 122 coupled to one another via a bidirectional communication link 123.

In this case, the partial simulation with real-time capability 121 is carried out on the real-time simulator 111, and the partial simulation without real-time capability 122 is carried out on the non-real-time simulator 112.

For example, the partial simulation with real-time capability 121 can thus simulate a vehicle engine to be controlled by the connected control unit 200, while the partial simulation without real-time capability 122 simulates an environmental component of the engine, such as a drive component. The operation of the control unit 200 in the engine control can thus be tested taking into account various drive models.

The simulation device 100, in particular the non-real-time simulator 112, may further comprise a log file 130. The partial simulation without real-time capability 122 and the partial simulation with real-time capability 121 can store the ping and pong messages exchanged during the simulation in the log file. After completion of the simulation, the log file 130 can be evaluated in order to thereby draw conclusions about possible simulation errors.

FIG. 1 is thus an example of a coupling of real-time and non-real-time components according to the invention. A plurality of control units should cooperate with one another. The first control unit 200 is already available with corresponding control unit hardware. Stimulation in real-time is provided from a real-time simulation of the environment (environmental model). This simulation (partial simulation with real-time capability 121) is executed on a simulator 111 with real-time hardware (for example, a hardware-in-the-loop simulator HIL from dSPACE). A second control unit is only present in rudimentary form in software (so-called virtual control unit) and can be simulated by a non-real-time simulator 112, i.e., for example, on a non-real-time PC with suitable simulation software (for example, VEOS of dSPACE) (partial simulation without real-time capability 122). The virtual control unit should now also process the data of the environmental model, i.e., of the partial simulation with real-time capability and of the first real-time control unit, or sends data to the first real-time control unit and the environmental model, which both utilize input in real time. The log file 130 is preferably stored on the non-real-time computer (PC).

In this case, the coupling of the partial simulation with real-time capability 121 and the partial simulation without real-time capability 122 can take place both synchronously and asynchronously.

In the case of a synchronous coupling, both partial simulations synchronize to a common master clock or to a common clock pulse generator.

In the case of asynchronous coupling, both partial simulations receive a start signal and attempt to run synchronously on the basis of their respective system clocks. The real-time system (or partial simulation with real-time capability) relates to a hardware clock that is very precise. The non-real-time system (or partial simulation without real-time capability) relates to a system clock, for example a network card in the system. The timers/clocks on a non-real-time system are not accurate enough to be able to guarantee real time. For a very large increment of the macrosimulation steps (at least 5 milliseconds), it is possible for the two simulations to run synchronously. For smaller increments, the non-real-time clock is generally too inaccurate such that the simulation times drift apart. The simulation time thereby is the time required for the simulation.

The partial simulations exchange simulation data for internal simulation calculations via the bidirectional link 123. The exchange of simulation data takes place at predetermined points in time, i.e., the partial simulation with real-time capability 121 and the partial simulation without real-time capability 122 work toward completing simulation data no later than at predetermined communication times and providing them to the respective other partial simulation.

However, in the coupling of real-time and non-real-time systems (such as SCALEXIO with VEOS), synchronization or system errors can occur due to the lack of hard real-time conditions on one side of the coupling. Thus, an invalid/faulty system state of the overall system may occur because data from one or more non-real-time simulation steps of the non-real-time side arrive with a delay on the real-time side, or data from one or more real-time simulation steps of the real-time side arrive with a delay on the non-real-time side. One or more task overruns on the real-time side may also occur due to a delayed calculation on the non-real-time side, which may in turn lead to an invalid/faulty system state of the overall system.

According to the invention, a simulation device and a method are provided for fine-granular recognition and efficient resolution of the cause of such real-time breaches in the system simulation.

In particular, conventional simulation methods are expanded by a ping-pong method which is called up in each simulation step and can generate a timestamp based on the simulation time. In this case, a ping message is generated on the part of the partial simulation without real-time capability, and it is sent to the partial simulation with real-time capability and a corresponding pong message is received from the partial simulation with real-time capability at the end of a simulation step (non-real-time system simulation step).

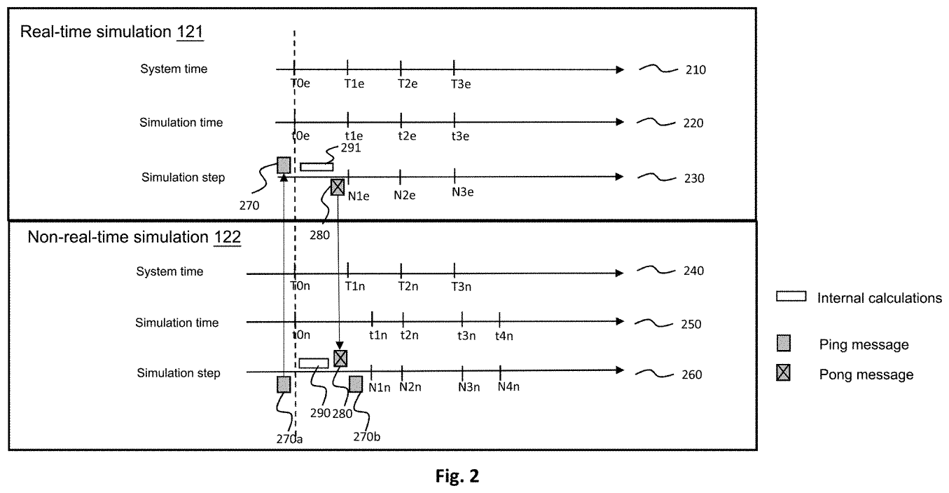

FIG. 2 shows the exchange of ping-pong messages between a partial simulation without real-time capability and a partial simulation with real-time capability in a temporal flow diagram. In this case, the partial simulation without real-time capability 122 may be executed by the non-real-time simulator 112 of FIG. 1 and the partial simulation with real-time capability 121 by the real-time simulator 11 of FIG. 1.

The real-time simulation 121 is shown in the upper region of FIG. 2, while the non-real-time simulation 122 is shown in the lower region. The partial simulation with real-time capability 121 comprises a real-time system time 210 and a real-time system simulation time 220 and is configured to simulate a part of the technical system 200 in a plurality of real-time system simulation steps 230. The partial simulation without real-time capability 122 comprises a non-real-time system time 240 and a non-real-time system simulation time 250 and is configured to simulate a further part of the technical system 200 in a plurality of non-real-time system simulation steps 260.

Since system times Ti and possibly also simulation times ti and simulation steps Ni may be different in real-time simulation and non-real-time simulation, these are indicated in FIG. 2 via the indices “n” (for non-real-time) and “e” (for real time). The control variable “i” specifies the chronological order of the steps.

In the real-time simulation 121, the simulation time 220 is at most equal to the system time 210; otherwise, there would be a task overrun. In the case of a task overrun, the calculation at the end of the time slot (or simulation step 230) available for this calculation is aborted in the real-time system and the next simulation step is carried out. However, the simulation may thereby be defective, i.e., the entire system may come into a faulty state. In the exemplary embodiment shown in FIG. 2, in the real-time simulation, the simulation time 220 is equal to the system time 210, as illustrated by the equidistant time periods T0e, T1e, T2e . . . (for the system time) and t0e, t1e, t2e . . . (for the simulation time).

In the non-real-time simulation 122, the simulation time 240 may deviate from the system time 250. If an attempt is made to calculate in quasi real time on the non-real-time system 112, this means that the non-real-time system 112 generally has calculated more quickly in a non-real-time simulation step than there is time available in this simulation step. Subsequently, the non-real-time system 112 waits until the simulation step has elapsed (corresponding to a predetermined amount of time) to provide the calculation result to the real-time system 111.

However, it is also possible for the non-real-time system 112 to take longer in a computing step/simulation step than the predetermined amount of time for the computing step. Task overrun then occurs. However, the non-real-time system 112 does not interrupt the simulation calculation at this point, but instead finishes the calculation so that all further steps are also calculated “too late”.

Therefore, the simulation time 220 of the real-time system and the simulation time 250 of the non-real-time system may be different. In the exemplary embodiment shown in FIG. 2, the simulation time, tin, 250 and the system time, Tin, 240 are different in the non-real-time simulation, as illustrated by the simulation time periods t0n, t1n, t2n . . . of different lengths, which do not coincide with the system time periods T0n, T1n, T2n . . . .

The corresponding real-time calculation step (or real-time simulation step Nie) can be ascertained from the system time and the simulation time of the partial simulation with real-time capability. The non-real-time calculation step (or non-real-time simulation step Nih) can be determined from the system time and the simulation time of the partial simulation without real-time capability.

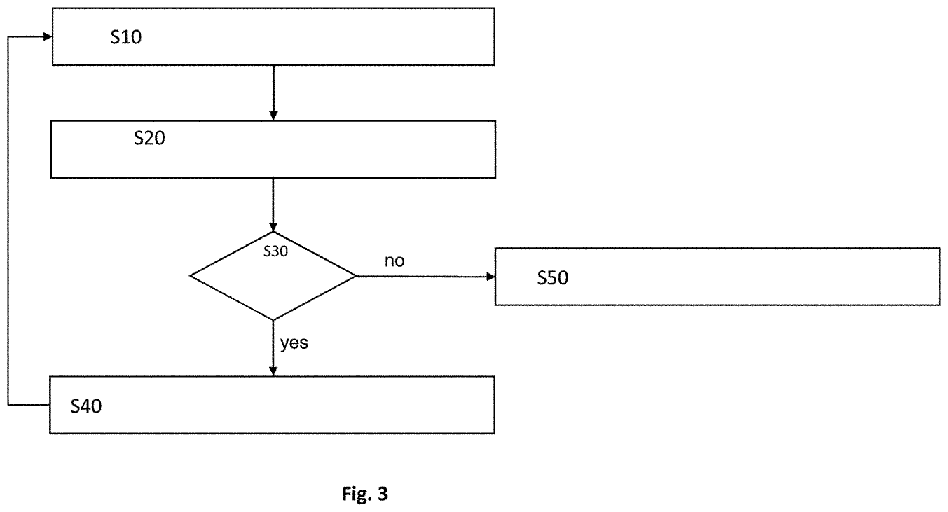

A method according to the invention for simulating a technical system will be described below with reference to FIG. 2 for an overall representation from the system point of view and with reference to FIG. 3 for a representation with reference to the partial simulation without real-time capability. FIG. 3 shows the steps on the part of the partial simulation without real-time capability according to a preferred embodiment.

Before the first step of the model to be simulated, a ping message (referenced by reference sign 270 in FIG. 2) is generated on the part of the partial simulation without real-time capability 122. This corresponds to step S10 in FIG. 3. The ping message may contain information about the non-real-time system simulation time 250 and the non-real-time system system time 240. This ping message is sent to the partial simulation with real-time capability (step S20 in FIG. 3) and can be received by the partial simulation with real-time capability. For example, at the beginning of the simulation, the message <Ping, t0n, T0n> is generated by the partial simulation without real-time capability in step S10 and sent to the partial simulation with real-time capability in step S20.

The partial simulation with real-time capability preferably receives this message even before the end of the last real-time simulation step and is then stored.

Then, both systems calculate their respective next simulation step 290, 291 (synchronously or asynchronously). As soon as the partial simulation with real-time capability 121 has finished calculating its simulation step, it sends the ping message back to the partial simulation without real-time capability 122 as a pong message.

The partial simulation without real-time capability 122 receives this message (step S30 in FIG. 3) and stores it in a log file after it has imprinted the current non-real-time simulation and non-real-time system time (step S40 in FIG. 3).

If no pong message is received from the partial simulation with real-time capability 121 on the part of the partial simulation 122 without real-time capability within the current simulation step, the partial simulation without real-time capability 122 saves the ping message in the log file (step S50 in FIG. 3).

Thereafter, the non-real-time side prepares the next ping message in order to send it to the real-time side in a timely manner for the next simulation step, and the steps shown in FIG. 3 on the part of the partial simulation without real-time capability 122 are carried out again. The generating of the next ping message thus marks the next exchange phase between the partial simulation without real-time capability 122 and the partial simulation with real-time capability 121.

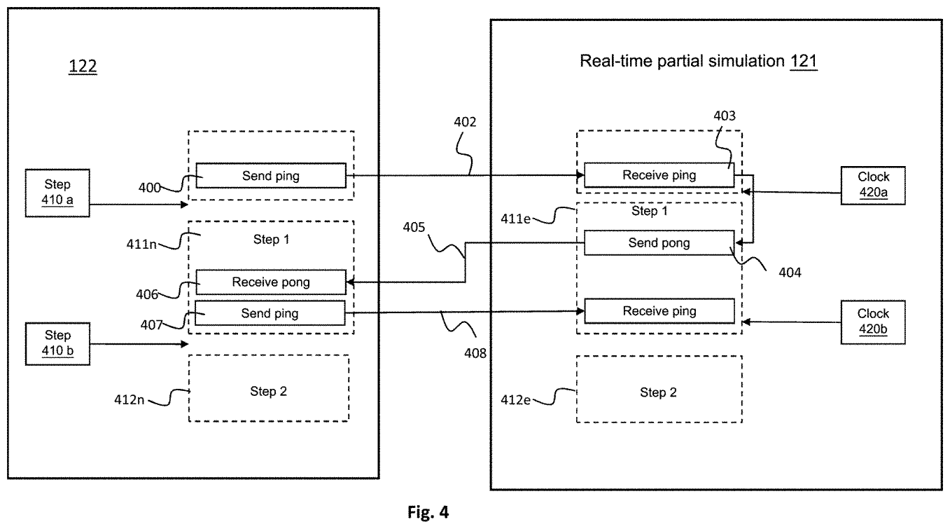

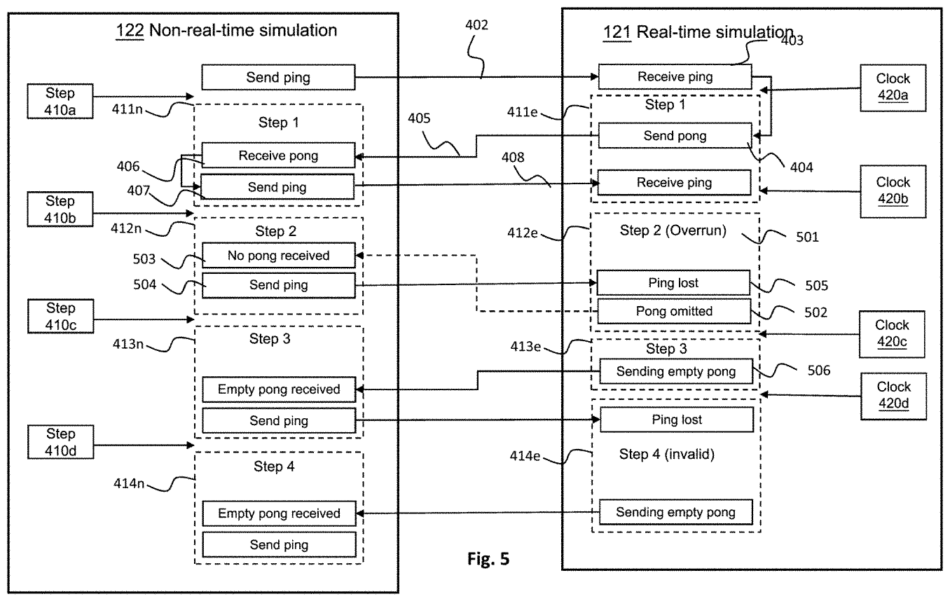

FIG. 4 shows a normal exchange phase when no synchronization error has occurred and the ping-pong messages were able to be transmitted successfully in each simulation step. FIG. 5 shows further exchange phases of ping-pong messages in different error scenarios. In the two figures, the step 410 relates to the macrosimulation step of the simulator, while the simulation steps on the part of the partial simulation without real-time capability 122 are denoted by the reference signs 411n, 412n, 413n, 414n and the simulation steps on the part of the partial simulation with real-time capability 121 are denoted by the reference signs 411e, 412e, 413e, 414e. The clock 420 indicates the system time that is the same for both partial simulations, as shown in FIG. 2.

Before the first step 411n of the model to be simulated, a ping message is generated on the part of the non-real-time partial simulation 122 (partial simulation without real-time capability) and sent 402 to the real-time partial simulation (partial simulation with real-time capability). The ping message is preferably generated 400; 407 and sent 402; 408 in every further non-real-time simulation step, in each case at the end of the non-real-time simulation step. If no simulation errors occur, the ping message should be able to be received by the partial simulation with real-time capability 121 before the end of the last real-time simulation step 403. In the next simulation step (shown in FIG. 4, step 1) both subsystems perform their local calculations (synchronously or asynchronously). As soon as the partial simulation with real-time capability 121 has completed its calculation, it sends 405 the ping message back to the partial simulation without real-time capability 122 as a pong message 404 without modification. In the case of synchronous coupling, the partial simulation without real-time capability 122 waits for this response 406 and stores the message in the log file after it has impressed the current simulation and system time (on the non-real-time side). Subsequently, the partial simulation without real-time capability 122 prepares the next ping message 407 in order to send 408 it to the partial simulation with real-time capability 121 for the next exchange phase (i.e., for the next simulation step 410) in a timely manner.

However, the partial simulation without real-time capability 122 can store the ping message in the log file without first waiting for the pong message of the partial simulation with real-time capability 121. This is advantageous if the partial simulation with real-time capability 121 does not send a pong message, for example due to a task overrun, as explained further below with reference to FIG. 5.

After an exchange phase according to FIG. 4 (corresponds to a run-through of the method steps of FIG. 3), if no synchronization error has occurred, a message is normally available on the part of the partial simulation without real-time capability 122 which can contain the following data:
system time when sending ping message (at the end of step n−1)
simulation time when sending ping message (at the end of step n−1)
system time when receiving the pong message (at the end of step n)
simulation time when receiving the pong message (at the end of step n).

Normally, if no synchronization error has occurred, then, for the embodiment shown in FIG. 4, the log file can contain the entry <<<Ping, t0n, T0n>, t1e, T1e>, t1n, T1n> after the first ping-pong message exchange phase. In this case, t0n, T0n denote the simulation or system time at which the partial simulation without real-time capability 122 generates the ping message; t1e, T1e denote the simulation or system time at which the partial simulation with real-time capability 121 generates the pong message; and t1n, T1n denotes the simulation or system time at which the partial simulation without real-time capability 122 receives the pong message.

However, as described at the outset, various error scenarios can occur in the coupling of partial simulations without real-time capability 121 with partial simulations with real-time capability 122 which result in a task overrun being generated on the real-time side or in similar overruns on the part of the partial simulation without real-time capability 122 resulting in an incorrect simulation result.

Various error scenarios are analyzed below with reference to FIG. 5.

The upper part of FIG. 5 (step 1) corresponds to the error-free exchange phase shown in FIG. 4. The corresponding steps are indicated by the same reference signs as in FIG. 4.

A distinction is made between the following exemplary error scenarios:
excessively long run times of a task on the part of the partial simulation with real-time capability (task overrun, step 2 in FIG. 5);
excessively long run times of a task on the part of the partial simulation without real-time capability (overrun of the soft real-time, steps 3 and 4 in FIG. 5);
delayed communication.

When a task overrun 501 occurs on the part of the partial simulation with real-time capability 121 (in step 2 in FIG. 5), the real-time side cannot generate 502 a pong message. Therefore, the partial simulation without real-time capability 122 does not receive a pong message in step 2, and 503 thus for step 2 only saves the ping message in the log file. Therefore, for the embodiment shown in FIG. 5 the log file at the end of step 2 contains the following entries:
<<<Ping, t0n, T0n>, t1e, T1e>, t1n, T1n>;
<<<Ping, t2n, T2n>, >, >.

The placeholders “_,_” indicate that, in the second step, no message has been received by the partial simulation with real-time capability 121 since it has not sent a pong message, and therefore no further reception times could be logged by the partial simulation without real-time capability 122. The second entry thus indicates an error which occurred on the part of the partial simulation with real-time capability 121 after the partial simulation without real-time capability 122 sent its ping message.

Due to the task overrun that occurred, the partial simulation with real-time capability 121 is also unable to receive the ping message 504 sent at the end of step 2 by the partial simulation without real-time capability 122 (“ping lost”, 505).

As a result of the fact that no ping message could be received at the end of step 2 by the real-time capable partial simulation 121, an empty pong message is generated in step 3, <, t3e, T3e>, which does not contain an associated ping message, and is sent 506 to the partial simulation without real-time capability 122. The empty pong message does not contain any information about the ping message. Optionally, the empty pong message can contain timestamps that record the simulation time (t3e) and the system time (T3e) of the real-time simulation at the time of generating/sending the (empty) pong message.

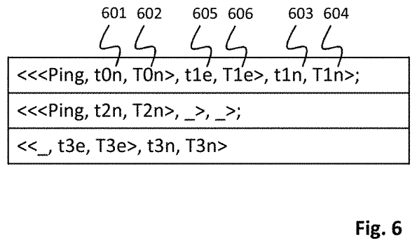

FIG. 6 shows the entries in the log file 130 at the end of step 3 for the embodiment shown in FIG. 5. These are:

| | |
|---|---|
| < < < Ping, t0n, T0n >, t1e, T1e >, t1n, T1n >; | //at the end of step 1 |
| < < < Ping, t2n, T2n >, _ >, _ >; | //at the end of step 2 |
| < < _, t3e, T3e >, t3n, T3n > | //at the end of step 3 |

wherein the following parameters can also be saved:

| | |
|---|---|
| t0n | Non-real-time system simulation time when generating/sending |
| | the first ping message (first non-real-time system timestamp 601); |
| T0n | Non-real-time system time when generating/sending the first |
| | ping message (second non-real-time system timestamp 602); |
| t1n | Non-real-time system simulation time when receiving the first |
| | pong message (third non-real-time system timestamp 603); |
| T1n | Non-real-time system time when receiving the first pong message |
| | (fourth non-real-time system timestamp 604); |
| t2n | Non-real-time system simulation time when generating/sending |
| | the second ping message; |
| T2n | Non-real-time system system time when generating/sending the |
| | second ping message; |
| t3n | Non-real-time system simulation time when receiving the second |
| | pong message (empty pong message); and |
| T3n | Non-real-time system system time when receiving the second pong |
| | message. |

The empty entry “_” in the third step denotes the empty pong message and is an indication that the partial simulation with real-time capability did not receive a ping message at the end of step 2.

Optionally, the entries may also contain the timestamps, which can add the partial simulation with real-time capability of the pong messages. Based on the above example, the parameters are:

| | |
|---|---|
| t1e/ | Real time system simulation time/system time when generating |
| T1e | the first pong message (first real-time system timestamp 605); |
| t3e/ | Real time system simulation time/system time when generating |
| T3e | the second pong message (second real-time system timestamp 606). |

In the above example, the ping message was optionally included in the log file in step 2 without an associated pong message being received by the partial simulation without real-time capability. A more accurate root cause analysis is thereby possible.

If, on the part of the real-time simulation, the task overrun from step 2 continues to extend beyond step 3, the (empty) pong message would be completely omitted in step 3 and the partial simulation without real-time capability would not receive a pong message. In this case, similar to step 2, the third entry in the log file would only consist of the ping message and would not contain any information about the partial simulation with real-time capability.

Thus, when a task overrun occurs on the real-time side, due to excessively long task runtimes no ping messages are received at the end of the step and no pong messages are sent. Therefore, the pong message is missing in this step and in the subsequent step on the non-real-time side (according to steps 2 and 3 in FIG. 4). For simulation environments in which no task overruns are allowed on the part of the partial simulation with real-time capability, the simulation aborts and therefore all following pong messages are missing.

A ping message can preferably be received on the part of the partial simulation with real-time capability only within a predetermined time window. A ping message sent on the part of the partial simulation without real-time capability as a result of a delay is considered to be lost on the part of the real-time simulation, whereby the generation of an empty pong message can be initiated in the next step (if no task overrun occurs in the step).

The following table summarizes the error scenarios described above on the part of the partial simulation with real-time capability:

| Receive ping | Task overrun | Action |
|---|---|---|
| yes | no | Send pong (contains ping) |
| yes | yes | Message is omitted |
| no | yes | Message is omitted |
| no | no | Send pong (empty) |

In other words, the partial simulation with real-time capability always sends a pong message in a real-time simulation step if no task overrun occurs in this real-time simulation step. If a ping message has been received in the preceding real-time simulation step, the pong message contains this ping message. If no ping message has been received in the preceding real-time simulation step, an “empty pong message” is sent, which is enriched with the corresponding real-time simulation time and real-time system time of the partial simulation with real-time capability.

In embodiments of a method according to the invention described above, the simulation times and the system times are stored in the log file on the part of the partial simulation without real-time capability and the one with real-time capability together with the corresponding ping-pong messages. After completion of the simulation, the respective simulation steps (non-real-time simulation steps and/or real-time simulation steps) in which the ping and/or pong messages were sent or received can be determined. However, it is also conceivable to explicitly carry the simulation steps in the ping-pong messages.

From the additional timestamps of the ping and pong messages, it can be checked, together with system logs or log files, whether at a specific system time and/or in a specific simulation step, during which simulation events have occurred which negatively affected the behavior of one or both partial simulations.

In addition, it is possible to determine from the “empty entries” in the log file in which simulation step a ping and/or a pong message has been lost and thus to conclude a simulation error in the corresponding step.

In the embodiments described above, the log file is described by the partial simulation without real-time capability. However, entries in the log file can also be made in a similar manner by the partial simulation with real-time capability.

By evaluating the log file, that simulation step (non-real-time simulation step and/or real-time simulation step, and thus also macro step of the simulator) in which an error has occurred during the simulation can thus be precisely determined. In conjunction with a profiler, system events or other processes which provoked the undesired behavior can also be identified.

It is thus possible to identify fine-granular and precise causes for real-time injuries in system simulation and to implement effective strategies for resolving them in a targeted manner.

In conjunction with a system log or profiler, system events or other processes that caused the undesired behavior can even potentially be identified. In this case, the profiler does not necessarily have to run parallel to the entire simulation but can, for example, be activated specifically at specific points in time or at simulation steps or after completion of the simulation, as a result of which the simulation performance is significantly less or not impaired at all.

Although the invention has been described with reference to exemplary embodiments, it is apparent to a person skilled in the art that various changes may be made and equivalents employed without departing from the scope of the invention. The invention is not intended to be limited by the specific embodiments described. Rather, it includes all embodiments covered by the appended claims.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for providing a simulation of a technical system, wherein the simulation comprises a partial simulation with real-time capability and a partial simulation without real-time capability coupled to the partial simulation with real-time capability,
wherein the partial simulation with real-time capability comprises a real-time system simulation time and a real-time system time and is configured to simulate a portion of the technical system in a plurality of real-time system simulation steps,
wherein the partial simulation without real-time capability comprises a non-real-time system simulation time and a non-real-time system time and is configured to simulate a further portion of the technical system in a plurality of non-real-time system simulation steps,
wherein the method comprises:
generating, by the partial simulation without real-time capability, a ping message;
sending, by the partial simulation without real-time capability, the ping message to the partial simulation with real-time capability; and
storing, by the partial simulation without real-time capability, in a log file, a pong message received from the partial simulation with real-time capability, or, in the event of no pong message being received from the partial simulation with real-time capability, storing, by the partial simulation without real-time capability, in the log file, the ping message.

2. The method according to claim 1, wherein the ping message comprises a first non-real-time system timestamp based on the non-real-time system simulation time and a second non-real-time system timestamp based on the non-real-time system time.

3. The method according to claim 1, further comprising:
determining, by the partial simulation without real-time capability, a current non-real-time system time and a current non-real-time system simulation time when receiving the pong message, wherein the pong message is stored in the log file together with the determined non-real-time system time as a third non-real-time system timestamp and the determined non-real-time system simulation time as a fourth non-real-time system timestamp.

4. The method according to claim 1, wherein a respective ping message is generated in each non-real-time system simulation step of the plurality of non-real-time system simulation steps and sent to the partial simulation with real-time capability.

5. The method according to claim 1, wherein for each real-time system simulation step of the plurality of real-time system simulation steps, the method further comprises:
checking whether a calculation to be performed within a respective real-time system simulation step has ended; and
generating a pong message and sending the pong message to the partial simulation without real-time capability based on the calculation in the real-time system simulation step having ended.

6. The method according to claim 1, wherein the pong message comprises a first real-time system timestamp based on the real-time system simulation time and a second real-time system timestamp based on the real-time system time.

7. The method according to claim 1, wherein the pong message contains the ping message based on the ping message having been received on the part of the partial simulation with real-time capability during a real-time system simulation step during which the pong message is generated.

8. The method according to claim 1, wherein the pong message does not contain any information about the ping message based on the ping message not having been received on the part of the partial simulation with real-time capability during a real-time system simulation step in which the pong message is generated.

9. The method according to claim 1, wherein the ping message is received on the part of the partial simulation with real-time capability within a predetermined time window.

10. The method according to claim 1, further comprising:
evaluating the log file; and
activating a profiler based on entries in the log file.

11. The method according to claim 10, wherein the profiler is activated on the part of the partial simulation without real-time capability after completion of the simulation.

12. A simulation device for simulating a technical system, wherein the simulation device comprises:
a partial simulation with real-time capability; and
a partial simulation without real-time capability coupled to the partial simulation with real-time capability;
wherein the partial simulation with real-time capability comprises a real-time system simulation time and a real-time system time and is configured to simulate a portion of the technical system in a plurality of real-time system simulation steps;
wherein the partial simulation without real-time capability comprises a non-real-time system simulation time and a non-real-time system time and is configured to simulate a further portion of the technical system in a plurality of non-real-time system simulation steps;
wherein the partial simulation without real-time capability is further configured to:
generate a ping message;
send the ping message to the partial simulation with real-time capability;
receive a pong message from the partial simulation with real-time capability; and
store the pong message in a log file.

13. The simulation device according to claim 12, wherein the non-real-time system simulation steps are based on the non-real-time system simulation time and the non-real-time system time, and wherein the real-time system simulation steps are based on the real-time system simulation time and the real-time system time.

14. The simulation device according to claim 12, wherein the simulation device is configured to evaluate the log file and to activate a profiler on the basis of entries in the log file.

15. A non-transitory computer-readable medium having processor-executable instructions stored thereon for providing a simulation of a technical system, wherein the simulation comprises a partial simulation with real-time capability and a partial simulation without real-time capability coupled to the partial simulation with real-time capability,
wherein the partial simulation with real-time capability comprises a real-time system simulation time and a real-time system time and is configured to simulate a portion of the technical system in a plurality of real-time system simulation steps,
wherein the partial simulation without real-time capability comprises a non-real-time system simulation time and a non-real-time system time and is configured to simulate a further portion of the technical system in a plurality of non-real-time system simulation steps,
wherein the processor-executable instructions, when executed, facilitate:
generating, by the partial simulation without real-time capability, a ping message;
sending, by the partial simulation without real-time capability, the ping message to the partial simulation with real-time capability; and
storing, by the partial simulation without real-time capability, in a log file, a pong message received from the partial simulation with real-time capability, or, in the event of no pong message being received from the partial simulation with real-time capability, storing, by the partial simulation without real-time capability, in the log file, the ping message.
